(19) United States
(12) Patent Application Publication
(10) Pub. No.: US 2023/0157444 A1
(43) Pub. Date: May 25, 2023

(54) MULTI-FUNCTIONALEXPANDABLE FOLDING TABLE ASSEMBLY

(71) Applicants: YIXIANG BLOW MOLDING FURNITURE CO., LTD., Yuyao (CN); Brian HOROWITZ, Mission Viejo, CA (US)

(72) Inventors: Jinglei JIANG, Yuyao (CN); Brian HOROWITZ, Mission Viejo, CA (US)

(73) Assignees: Brian HOROWITZ, Mission Viejo, CA (US); YIXIANG BLOW MOLDING FURNITURE CO., LTD., Yuyao (CN)

(21) Appl. No.: 17/656,858

(22) Filed: Mar. 28, 2022

(30) Foreign Application Priority Data
Nov. 19, 2021 (CN) 202111318562.7

(51) Int. Cl. A47B 3/087; A47B 3/10

(52) U.S. Cl. CPC A47B 3/087; A47B 3/10; B62B 1/10

(57) ABSTRACT

The present subject matter discloses a multi-functional expandable folding table. The first panel and the second panel of the table are connected by a pivot device. The first panel has a retractable frame, including a fixed frame connected with the pivoting device and a movable frame slidably arranged on the fixed frame. The fixed frame is provided with a movable insert panel, which can be horizontally arranged between the first panel and the second panel. It also renders easy transportation and storage With its unique and intricate structures, the expandable folding table can provide multiple functions without interfering with each other.

### CROSS-REFERENCES TO RELATED APPLICATIONS

This application claims the priority of CN Patent Application No. CN202111318562.7, entitled “Expandable Folding Table,” filed Nov. 9, 2021, which is incorporated herein by reference for all purposes.

### TECHNICAL FIELD

The present subject matter is in the field of furniture design and manufature. More particularly, embodiments of the present subject matter relate to a multifunctional expandable folding table with a retractable insert panel. Furthermore, the folding table can be used as a cart when it is folded.

### BACKGROUND

An expandable table can be extended when there is more table space needed. When the extra table spaces is not needed, the expandable table can be shortened so that it takes less space.

A folding table can be folded to reduce the storage space and makes it convenient to carry. However, although the traditional folding table can be folded, the table top cannot be expanded. After being unfolded, the length of the table top can not be adjusted or extended according to the number of seats needed. An example of such a folding table structure is disclosed in Chinese Patent No. CN207428721U.

In addition, it is difficult to mobilize the traditional expandable table and the folding table, especially those with large, double-panel table tops. In order to enable easy transportation, a wheel structure for the table can be provided.

Furthermore, there is a continuous need to provide more improvement and functions to the traditional table. For example, in addition to being more portable, a table can serve the function of a trolley for lugging various items, such as chairs, food, display equipment, and promotional materials for exhibitions.

In view of the above situation, for example, Chinese patent application CN203920813U (“A Multi-purpose Trolley with the Interchangeability of Table and Trolley Functions”) and Chinese patent application CN210471373U (“A Multifunctional Table) both disclose a table that can be used as a table and a cart. However, the table tops of these tables are a single board that cannot be too big, or they would be too difficult to be transported. In addition, the transported objects are placed on the table top, which might cause damages if the tabletop does not have enough load-bearing capacity.

Therefore, there is a need for a multi-functional table that is foldable and expandable. When it is folded, the table can also provide the roller function and trolley.

### SUMMARY OF THE SUBJECT MATTER

The present subject matter can solve the first technical problem as described herein by providing a folding table with a retractable insert panel in view of the present state of the art.

The present subject matter can solve the second technical problem as described herein by providing an expandable folding table that can be easily rolled away and can work as a trolley for transporting objects.

The technical solution adopted in the first technical problem to be solved by the present subject matter is as follows: an expandable folding table that comprises a foldable table top that includes a first panel and a second panel that are configured to be coupled with each other. It further has a foldable table frame that includes a first frame with a first stand connected to the first panel and a second frame with a second stand connected to the second panel. The first frame and the second frame are connected by a pivot device and can be folded around a pivot shaft of the pivoting device to achieve folding. The first frame is expandable, which includes a fixed frame connected with the pivot device and a movable frame slidably arranged on the fixed frame, and a movable panel is mounted on the fixed frame. The movable frame and the first panel are configured to slide on the fixed frame through a sliding rail device between the movable frame and the fixed frame, so that the movable panel can be horizontally arranged between the first panel and the second panel to extend the expandable folding table when it is in use, and the movable panel can be hidden under the first panel when it is collapsed.

According to some embodiments, the movable panel can be rotatably connected to a middle beam of the fixed frame, and the movable panel can be foldable with a first board and a second board that are connected to each other. Various mechanisms can be used to connect the first board and second board. For example, the connection can be through hinges, or through a flexible integrated hinge structure with rotatable thinner plastic. This way, the movable panel, or the retractable insert panel, can be easily expanded or collapsed. When the movable panel is folded and stored under the first panel, an anti-detachment device can be placed between the first board and the second board to prevent them from detachment. For example, the anti-detachment device can be a magnet to attach the two boards to each other.

According to some embodiments, the fixed frame can be shaped like a square or a rectangle. The fixed frame can include a longitudinal front fixed beam and a longitudinal rear fixed beam, and a horizontal left fixed beam and a horizontal right fixed beam, wherein the longitudinal front fixed beam and the longitudinal rear fixed beam are respectively connected to the front and rear of the pivot device, wherein the horizontal right fixed beam is connected between the front and rear of the pivot device. Furthermore, the movable frame can include a longitudinal front movable beam and a longitudinal rear movable beam, and the longitudinal front movable beam and the longitudinal rear movable beam are slidably arranged on the longitudinal front fixed beam and the longitudinal rear fixed beam. The middle beam can be a longitudinal beam connected between the horizontal left fixed beam and the horizontal right fixed beam.

According to some embodiments, the sliding rail device further comprises the longitudinal front fixed beam and the longitudinal rear fixed beam, each being provided with fixed sliding rail grooves with rolling elements. The longitudinal front movable beam and the longitudinal rear movable beam are provided with movable sliding rail grooves configured to match with the rolling elements. Furthermore, a limiting structure for limiting the movable sliding rail grooves on the fixed sliding rail grooves can be provided. According to some embodiments, the limiting structure can include or more limiting blocks and limiting protrusions to prevent the first panel's unlimited movement.

According to some embodiments, the rolling elements can be one of a roller, a bearing, or a roller, or a combination thereof.

According to some embodiments, the first stand can be connected with the movable frame. When the first panel slides on the rail, the first stand and the movable frame can move along with the first panel. This way, the first panel can be supported by the first stand and the movable frame to provide bearing strength.

According to some embodiments, the first panel, the second panel, and the movable insert panel can be blow molding panels. Furthermore, the movable insert panel has grooves to match with protrusions on the first and second panels when the movable panel is inserted between the two panels. For example, when the first panel and second panel are coupled directly, the lower side of the abutting surfaces of the two panels have interlocking grooves and protrusions to mate with each other. Meanwhile, the upper side of the abutting surfaces has a straight contact to ensure the coupled table top appears to be flat and smooth. When the movable panel is inserted between the two panels, the upper side of the abutting surface also has a straight contact, and the lower side can have interlocking grooves and protrusions or bumps. As such, the inserted movable panel can securely interlock with the first panel and the second panel without causing warping or uneven table top. It can further improve the structural stability of the coupled panels.

The technical solution adopted in the second technical problem to be solved by the present subject matter is as follows: the expandable folding table can have two-wheel modules that can be foldably arranged near the second panel. When the expandable folding table is in use, the wheel modules are configured to be stored under the second panel. When the expandable folding table is collapsed or folded, the wheel modules are configured to provide rolling on the ground. Furthermore, according to some embodiments, a pulling rod installed at the bottom of the second panel can be pulled out of the second panel.

According to some embodiments, the expandable folding table can have at least one bearing frame arranged on the bottom of the first panel and/or the second panel. At least one bearing frame can be pulled out and locked at a fixed carrying position by a rotating structure, which can be used to transport objects such as chairs.

With the aforementioned features, the expandable folding table can not only adjust the table's length but also provide the dual functions of a table and a cart. It renders efficient transportation of the table and other items, brings more convenience to outdoor activities, and makes it easier to set up exhibitions and other activities.

According to some embodiments, the pulling rod can adopt different structures, such as a simple retractable rod. Preferably, a pulling rod of conventional luggage can be adopted, which includes a pair of rods fixed at the back of the panels. The pair of rods can have a retractable pulling mechanism featuring, e.g., a handle and a button to control and adjust the length of the rods.

According to some embodiments, the expandable folding table can have a locking mechanism between the first panel and the second panel when the expandable folding table is folded. This way, when the table is used as a cart, the two panels can be securely locked together.

According to some embodiments, the expandable folding table can have a first bearing frame arranged on the bottom of the first panel and a second bearing frame arranged on the bottom of the second panel. When the table is folded, the first bearing frame can be on the same side as the pulling rod, and the first bearing frame can be locked at a perpendicular angle to the folded panels by a rotating structure. Furthermore, the second bearing frame can protrude between the hinge of the first panel and the second panel and be locked at a perpendicular angle to the folded panels. This way, the upper first bearing frame can carry objects such as chairs or bags, and the lower second bearing frame can carry objects such as a cooler or a suitcase. All such objects can be lugged by the expandable folding table. According to some embodiments, to enable functions of the pulling rode and bearing frames, one or more gaps can be provided at the bottom of the first panel and the second panel.

According to some embodiments, the expandable folding table can have a locking mechanism between the first panel and the second panel when the expandable folding table is folded. The locking mechanism can comprise a lock latch and a lock post, respectively mounted on the first panel and the second panel. According to some embodiments, the lock latch can be rotatable. Such a locking mechanism can be hidden between the panels so that it does not affect the aesthetic appearance and is convenient for operation.

According to some embodiments, the first bearing frame and the second bear frame can be U-shaped, each comprising a pair of parallel bearing outer tubes, which further comprise retractable and lockable rods. According to some embodiments, the bearing frames can adopt other shapes as well.

According to some embodiments, each of the first bearing frame and the second bearing frame can be formed by a split upper rod and lower rod. The split upper rod can be U-shaped, with both ends connecting with the lower rod through the rotating structure. The end of the lower rod is flat with two sides flattened, and the outer edge surface has a vertical plane, an inclined plane and an arc surface in sequence along the length direction of the lower rod. Accordingly, the end of the upper rod is provided with an accommodating opening, and the end of the lower rod is inserted into the accommodating opening and connected by a rotating shaft. In this way, when the upper rod is pulled out, the wall surface of the receiving opening of the upper rod opposite the end of the lower rod is in contact with the vertical plane of the end of the lower rod, and the inclined surface on the upper rod can limit their relative rotation so that the upper rod can be locked in 90 degrees or approximately 90 degrees upward. Only when there is external force, the upper rod can be rotated along the inclined surface, and the arc surface until the upper and lower rods are in a horizontal state. At this state, the upper rod can be retracted into the outer tube of the bearing frame.

According to some embodiments, the bottoms of the first panel and the second panel have limiting slots for fixing the positions of the wheel modules. As such, when the table is folded and packed, the two-wheel modules can be restrained between the limiting slots of the panels without excessive vibration or movement. According to some embodiments, the shape of the limiting slots can match the shape and size of the wheel modules.

Compared with the prior art, the advantages of the present subject matter include: the present expandable folding table breaks away from the traditional folding table that cannot be extended. With its unique and intricate structures to provide multiple functions, the expandable folding table can additionally provide length adjustment and object-lugging functions that do not interfere with each other.

In addition, when the table is not extended, the movable insert panel is hidden under the panels, which does not affect the appearance and use of the table. When the table is folded and packed, the movable panel and the two-wheel modules can be accommodated in the space formed by the two panels folded in half. Furthermore, after folding, the size of the entire table is only the size of one panel, which greatly reduces the packaging volume, thereby reducing packaging and transportation costs. It also renders easy transportation and storage.

### DESCRIPTION OF DRAWINGS

The present subject matter is illustrated by way of example, and not by way of limitation, in the figures of the accompanying drawings and in which:

FIG. 1 is a schematic diagram of an embodiment of the present subject matter when the table top is not extended.

FIG. 2 is a schematic diagram of the first panel in FIG. 1 in an exploded view.

FIG. 3 is a schematic diagram of the disassembled first and second panels and the movable panel in the inverted view of FIG. 1.

FIG. 4 is a schematic diagram of an embodiment of the present subject matter after the first panel is pulled out.

FIG. 5 is a schematic diagram of the inverted view of FIG. 4.

FIG. 6 is a schematic diagram of the extended state of the table top after the movable panel in FIG. 4 is unfolded and inserted.

FIG. 7 is a schematic diagram of the inverted view of FIG. 6.

FIG. 8 is a schematic diagram of the first and second panels and the movable panel in FIG. 6 after being disassembled.

FIG. 9 is a three-dimensional schematic diagram of the embodiment of the present subject matter in a folded state (the pull rod is pulled out).

FIG. 10 is a schematic view of FIG. 9 after the bearing frames are pulled out.

FIG. 11 is a schematic view of FIG. 9 after disassembling the first panel.

FIG. 12 is a perspective view of a retractable rod of a bearing frame according to an embodiment of the present subject matter.

FIG. 13 is a view reflecting the retractable rod of the bearing frame in FIG. 12 is rotated and locked.

FIG. 14 is an enlarged schematic diagram of part A of FIG. 13.

FIG. 15 is an exploded schematic view of FIG. 13.

FIG. 16 is an enlarged schematic diagram of part B of FIG. 15.

FIG. 17 is a schematic diagram of an embodiment of the present subject matter in a folded and packaged state.

FIG. 18 is a schematic view of FIG. 17 after disassembling the first panel.

### DETAILED DESCRIPTION

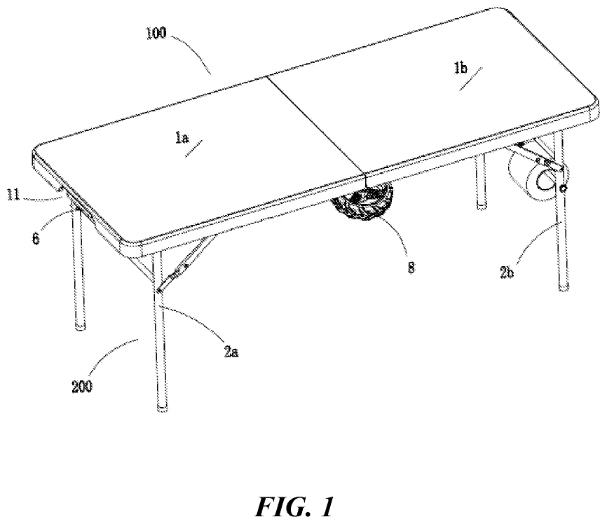

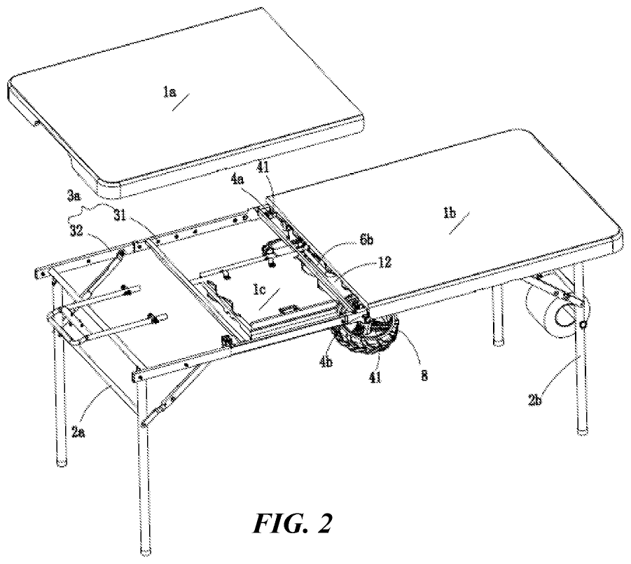

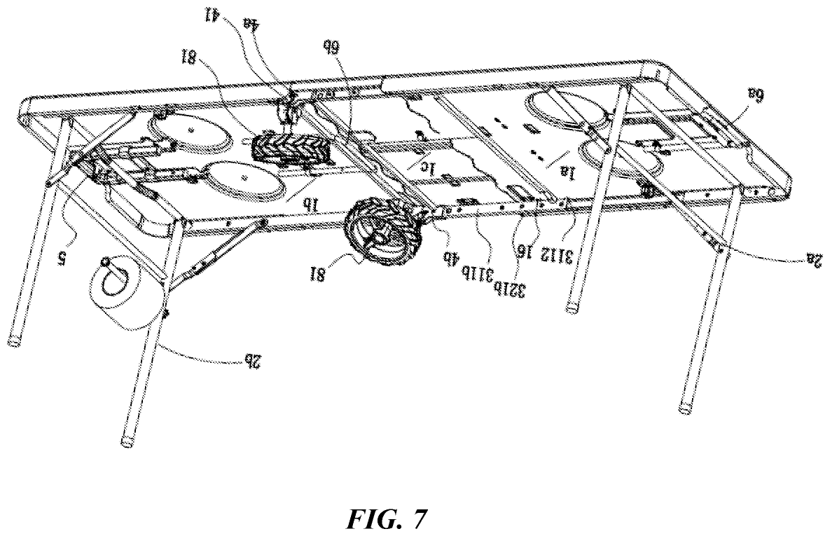

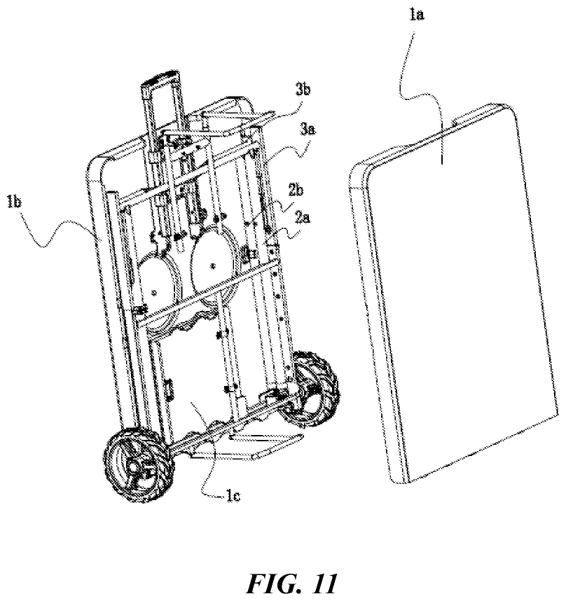

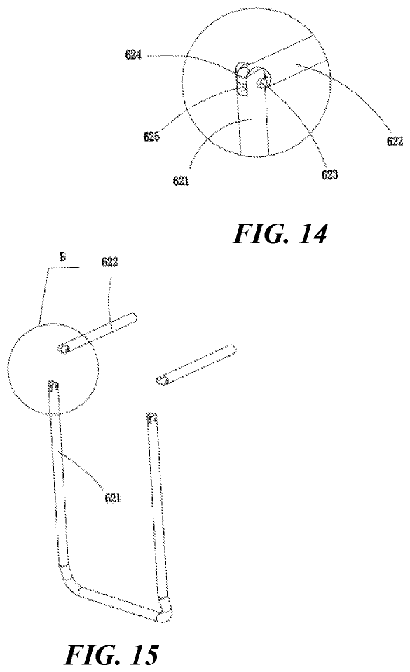

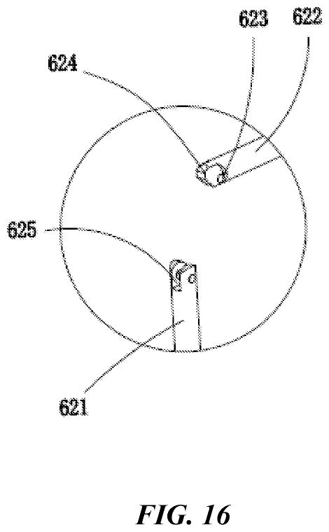

The present subject matter pertains to improved approaches for a multi-function expandable folding table assembly. Embodiments of the present subject matter are discussed below with reference to FIGS. 1-18.

In the following description, for purposes of explanation, numerous specific details are set forth in order to provide a thorough understanding of the present subject matter. It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as they are merely intended to provide examples of embodiments of the subject matter rather than to provide an exhaustive list of all possible implementations. In other instances, well-known structures and devices are shown in block diagram form in order to avoid obscuring the details of the disclosed features of various described embodiments.

The present subject matter will be further described in detail below with reference to the embodiments of the accompanying drawings.

As shown in FIG.s 1-18, the expandable folding table includes foldable table top 100, foldable table frame 200, wheel modules 8, bearing frame 6 and pulling rod 5, etc., in which:

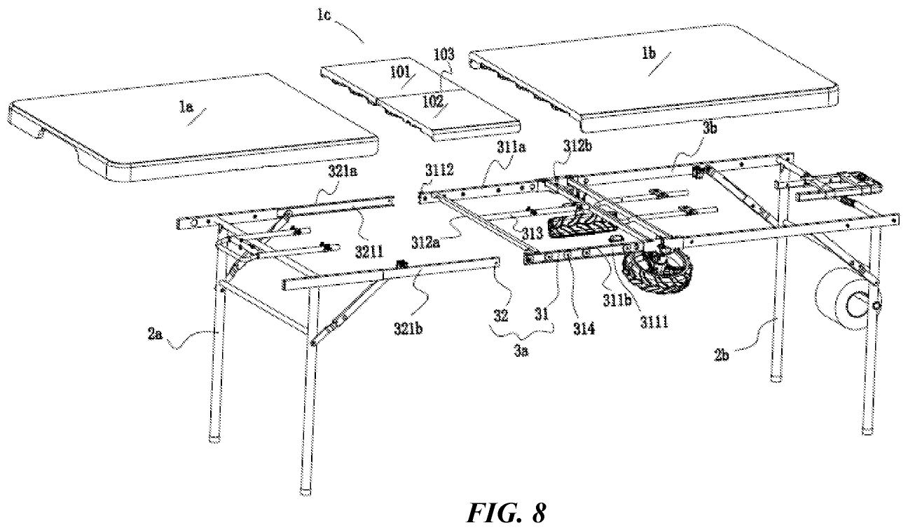

According to some embodiments, the foldable table top 100 includes a first panel 1a, a second panel 1b, and a movable panel 1c. The first panel 1a and the second panel 1b have the same shape, size or substantially the same size (as shown in FIG. 8). However, it is not limited to the same size. According to specific needs, the first and second panels 1a and 1b can be adjusted. The movable panel 1c can be inserted between the first and second panels 1a, 1b to extend the length of the table top. There may be one or more movable panels 1c, and the present subject matter discloses one movable panel as an example.

In order to suit the outdoor use of the folding table, the first and second panels 1a, 1b and the movable panel 1c are hollow blow-molded panels (the concave structure at the bottom of the panels is omitted in the figures). According to some embodiments, the opposite sides of the first and second panels 1a, 1b, that is, the lower parts of the butting surfaces to be butted against each other, are integrally formed with staggered grooves 14 and bumps or protrusions 13. Meanwhile, the upper side of the abutting surfaces has a straight contact to ensure the coupled table top appears to be flat and smooth, while the lower side is fitted and butted with the grooves 14 and the bumps 13 between each other.

Similarly, the left and right sides of the movable panel 1c are the butt surfaces that are respectively connected to the first and second panels, and the lower parts of the two sides are also integrally formed with staggered grooves 14 and bumps 13.

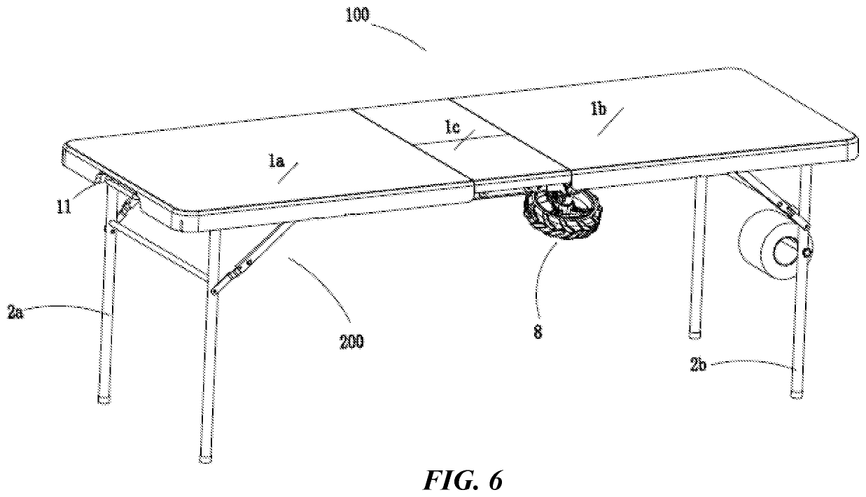

As shown in FIG. 6, when the folding table is open and extended, the movable panel 1c is connected to the first and second panels 1a and 1b, the upper side parts of the butt surfaces are also flat butt joints, and the lower side parts are also fitted and butted with the grooves 14 and the bumps 13. The bumps 13 on the first and second panels 1a and 1b are fitted with the grooves 14 on the first and second panels 1a and 1b, and the grooves on the movable panel 1c are fitted with bumps 13 on the first and second panels 1a and 1b. The aforementioned features can not only improve the structural strength of the coupled panels but also reduce the joints and ensure the flatness and aesthetics of the foldable table top 100.

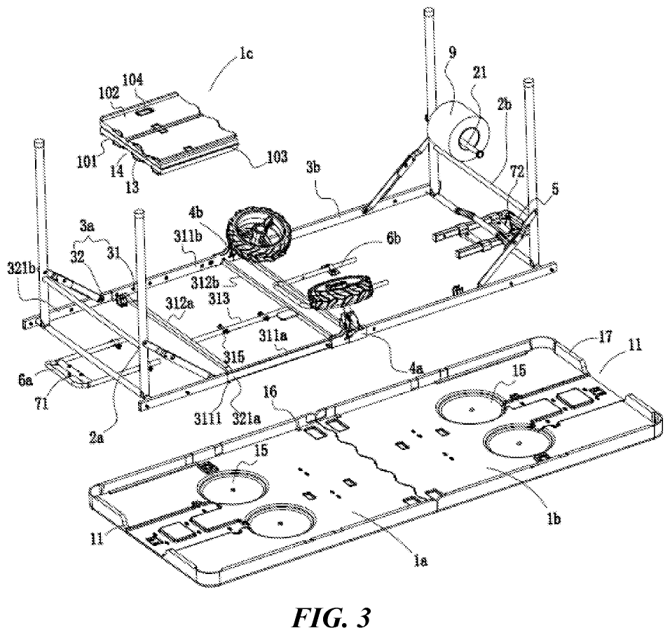

As shown in FIG. 3 , the movable panel 1c is a foldable panel, which comprises a first board 101 and a second board 102 that are connected together, and the connected parts can be folded in half. There can be many mechanisms to connect the two boards. For example, the material skin 103 as shown in FIG. 3 can be used to connect the first board 101 and the second board 102, i.e., a plastic joint has thinner material than the two boards'. It can also be connected through hinges so that the movable panel 1c can be easily unfolded or folded. In order to prevent the folded first board 101 and the second board 102 from being detached, an anti-detachment device can also be provided between the first board 101 and the second board 102. The device can use a simple magnetic device. That is, the first board 101 and the second board 102 are respectively equipped with strong magnets 104 that can be attracted to each other so that the unconnected sides of the two boards can be firmly attracted together.

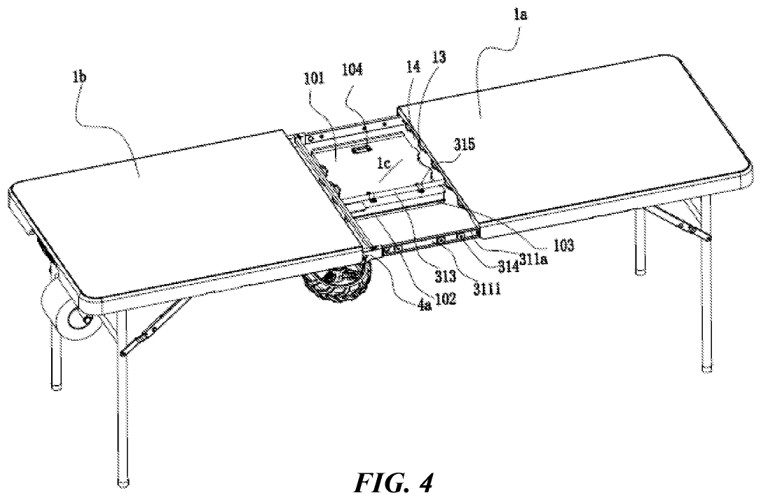

According to some embodiments, the movable panel 1c is hidden under the first panel 1a when the table top does not need to be lengthened and is rotatably connected to the middle beam 313 of the fixed frame 31. When the table top needs to be extended, after pulling the first panel 1a, the movable panel 1c can be rotated and inserted. After unfolding the first board 101 and the second board 102, they can be supported on the fixed frame 31, so that the movable panel 1c can be locked between the first panel 1a and the second panel 1b. This way, the extension of the table top is achieved, as shown in FIGS. 4-FIGs. 6. The front and rear sides of the movable panel 1c are also provided with downwardly extending flanges, which can cover the fixed frame 31.

According to some embodiments, foldable table frame 200 can mainly include a first frame 3a and a first stand 2a connected to the first panel 1a, and a second frame 3b and a second stand 3a connected to the second panel 1b; The first frame 3a and the second frame 3b are connected by the front and rear pivot devices 4a, 4b and can be folded around the pivot shaft 41 and linked with the first panel 1a and the second panel 1b to achieve folding. Among them, the first stand, the second stand, the second frame, and the front and rear pivoting devices can all adopt conventional structures and thus will not be repeated here. However, it should be noted that they can be modified with other well-known technologies except the embodiments as shown here.

According to some embodiments, the first frame 3a of the present subject matter is a retractable frame, which includes a fixed frame 31 connected to the front and rear pivoting devices 4a, 4b and a movable frame 32 slidably arranged on the fixed frame. The movable panel 1c is mounted on the fixed frame and can be rotatably opened. The first panel 1a and the first stand 2a are fixedly connected to the movable frame 32 and linked with the movable frame 32 . A slide rail device is provided between the movable frame 32 and the fixed frame 31, so that the first panel 1a can move back and forth on the fixed frame 31. When the table top is to be extended, only the first panel 1a needs to be pulled away from the second panel 1b, so that the movable panel 1c can be pulled out and connected to the second panel 1b horizontally. This way, the table top is in the extended state in which the first panel 1a, the movable panel 1c and the second panel 1b are spliced together, as shown in FIG. 6.

According to some embodiments, when the table does not need to be extended, the first panel 1a and the second panel 1b are butted, whereas the movable panel 1c is folded and stored under the first panel 1a. Furthermore, the movable insert panel 1c cannot be seen on the table top, as shown in FIGS. 1-3.

According to some embodiments, the fixed frame 31 is roughly in the shape of a square or a rectangle, which includes front and rear side beams 311a and 311b in the longitudinal direction (referring to the longitudinal direction of the table top), and left and right fixed beams 312a and 312b in the horizontal direction (referring to the width direction of the table top). The front and rear fixed beams 311a, 311b are respectively connected with the pivot seats of the front and rear pivoting devices 4a, 4b, and the right fixed beam 312b is connected between the front and rear pivoting devices 4a, 4b. In order to arrange the middle beam 313 of the movable panel 1c longitudinally, it is connected between the left fixed beam 312a and the right fixed beam 312b. A baffle plate is also extended on the fixed beam 312b for supporting and positioning the movable panel 1c. The front fixed beam 311a and the rear fixed beam 311b are both long strip-shaped plates with a “[”-shaped cross-section, with the grooves on them are set as fixed sliding rail grooves 3111. A plurality of rolling elements 314 is arranged at intervals in the fixed sliding rail groove 3111. According to some embodiments, the rolling elements 314 can be rollers, bearings, or rollers, etc., and are rotatably arranged in the length direction.

According to some embodiments, the shape of the movable frame 32 is basically the same as that of the second frame 3b, and the main difference is that the longitudinal front movable beam 321a and the rear movable beam 321b are designed to be slidable structures matched with the fixed frame 31. Specifically, the front movable beam 321a and the rear movable beam 321b and the front and rear fixed beams 311a, 311b are matched with a long strip-shaped plate with a “]”-shaped cross section, with the groove on it set as a movable sliding rail groove 3211, which is slidably in contact with the outer circular rolling surface of the rolling element 314 in the fixed sliding rail groove 3111.

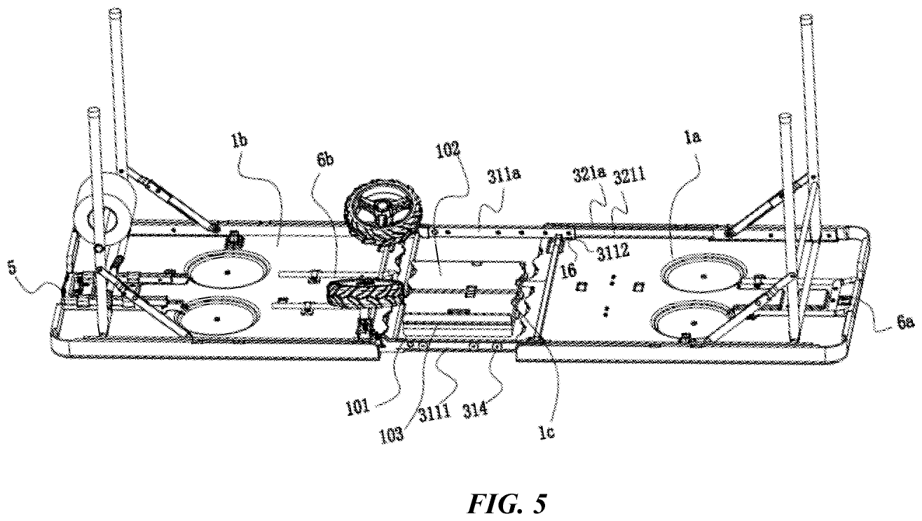

In addition, a limit structure is provided between the movable sliding rail groove 3211 and the fixed sliding rail groove 3111 to limit the displacement of the movable sliding rail groove 3211 on the fixed sliding rail groove 3111, which can limit the maximum pulling distance of the first panel 1a, to prevent infinite pullout. It can be realized by the following structure: a limiting block 3112 is protruded on the lower side of the left ends of the front and rear fixed beams 311a, 311b respectively, and correspondingly on the front and rear sides of the back of the first panel 1a are raised to form a limiting protrusion 16 that can collide with the limiting block 3112 . When the limiting protrusions 16 on the first panel 1a collide with the limiting blocks 3112 on the front and rear fixed beams 311a, 311b, the first panel 1a can no longer be pulled out, as shown in FIG. 5.

According to some embodiments, the first stand 2a is connected with the movable frame 32. When the first panel 1a slides back and forth, the movable frame 32 and the first stand 2a also move together. Therefore, the bottom of the first panel 1a is always supported by movable frame 32 and first tripod 2a to ensure its bearing strength.

In addition, in order to facilitate the placement of some objects, without interfering with the folding of the table, one or more rods 21 can be added so that objects such as towl paper 9 can be hung on it. According to som embodiments, there can be a hole on the table top, which can be used for placing a wire. The hole can be sealed with a cover when not in use (not shown in the drawings).

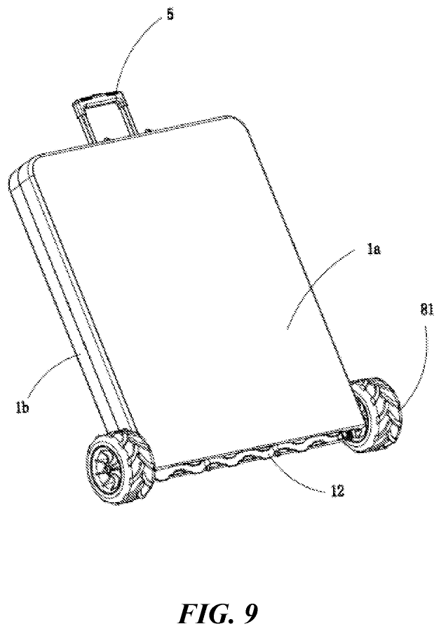

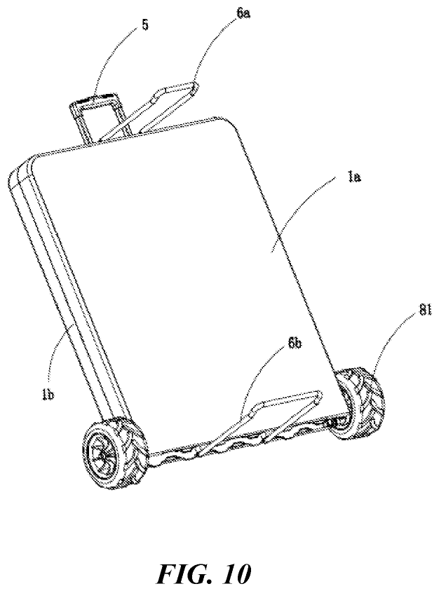

In addition to the retractable table top, the expandable folding table of the present subject matter can also be used as a cart after being folded (as shown in FIG. 9 and FIG. 10). It is mainly implemented by the wheel module or trolley 8, the pulling rod 5 and the bearing frame 6 etc., which are installed at the bottom of the table top, in which:

There are two-wheel modules, which are installed on both sides of the bottom of the second panel 1b in the width direction, adjacent to the butt joint 12 of the first and second panels. When the table is folded, the wheels 81 of the pulley member can extend out of the foldable table top 100, and can roll on the ground. The position of the pulleys will not affect the folding of the table and the frame. When the table is to be folded and packed, the wheels 81 can be folded and removed and placed in the cavity between the movable panel 1c and the frame without excessive vibration or shaking.

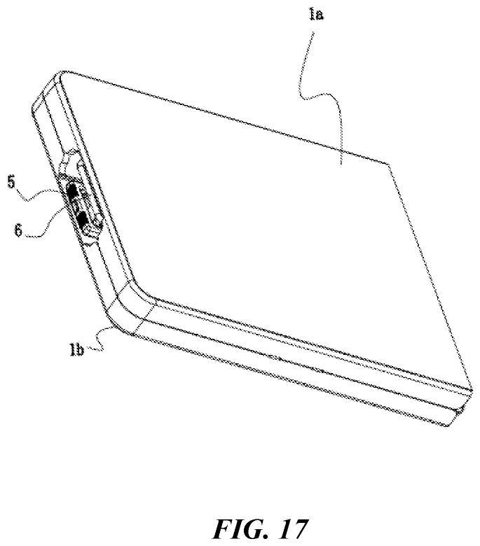

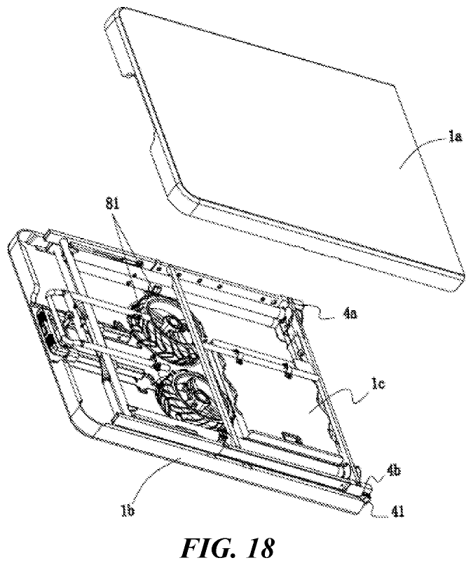

According to some embodiments, the limiting slots 15 are recessed on the bottoms of the first panel 1a and the second panel 1b, with the shape and size matching the wheels, as shown in FIG. 18. After the expandable folding table is folded, the size of the entire table is only that of one main panel, so the packaging volume can be greatly reduced. It can greatly reduce packaging and transportation costs and is also convenient for storage and carrying, as shown in FIG. 17.

As shown in FIG. 9, the pulling rod 5 is installed in the middle of the right side of the second panel, and is arranged in a T-shape with the two pulleys 3. The pulling rod 5 can be pulled from the bottom of the second panel 1b along the length direction. Therefore, the edge convex edge 17 extending downward from the middle part of the right side of the second panel 1b is provided with a vacant notch 11 for the pulling rod. The pulling rod 5 can be implemented with different structures, such as a relatively simple retractable rod-like structure. However, the pulling rod 5 as shown in FIG. 5 adopts a pulling rod of a conventional trolley, which will not be described here.

According to some embodiments, there can be one or more bearing frames 6. In this embodiments, to meet the needs of an object hanging and lugging, it is preferable to use the two bearing frames as shown. The bearing frames 6 also extend out of the foldable table top 100 by pulling it out (similarly, there is a gap 11 for the frame to be pulled out perpendicular to the panels). The bearing frames 6 can be rotated by a rotating structure 620 and locked relative to the table top, as shown in FIG. 10.

According to some embodiments, the first bearing frame 6a and the second bearing frame 6b are respectively arranged on the first and second panels 1a and 1b, so that when the table is folded, the first bearing frame 6a and the pulling rod 5 are on the same side. The second bearing frame 6b protrudes from the butt joint 12 of the first and second panels, i.e., the gap between the first and second main panels, and is on the same side as the lower pulley. This way, the first bearing frame 6a is suitable for hanging objects such as chairs, the second bearing frame 6b is suitable for placing objects such as packaging boxes, the cooler, etc., as shown in FIG. 10.

In order to facilitate hanging/lugging objects with improved bearing strength, the bearing frame 6 can be made into a U-shaped structure, which includes a pair of bearing frame outer tubes 61 fixed on the bottom of the table, and the outer tube of the bearing frame is assembled with retractable rods, i.e., the U-shaped bearing frame retractable rod 62. The bearing frame retractable rod 62 is provided with a rotating mechanism 620, through which the retractable rod can be locked in a state perpendicular relative to the table panel. Other bearing frame designs can also be used to implement the present subject matter.

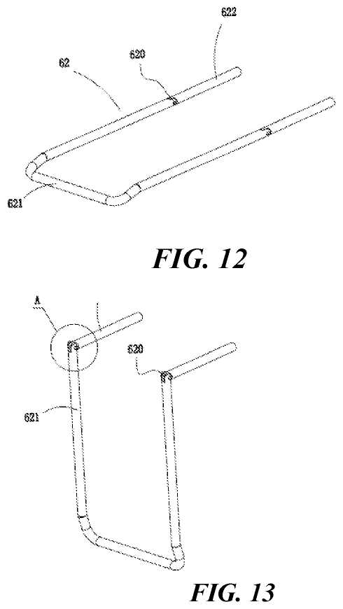

As shown in FIGS. 12-16, the retractable rod 62 of the bearing frame is formed by connecting a split upper rod 621 and two lower rods 622. The upper rod 621 is U-shaped, and its two ends are respectively connected to the lower rod 622 through a rotating mechanism 620. The end of the lower rod 622 is in a flat shape with both sides flattened, and the outer edge surface 624 has a vertical plane, an inclined surface, and an arc surface in sequence along the length direction of the lower rod. The end of the upper rod 621 is provided with an accommodating port 625 in the middle, and the end of the lower rod is inserted into the accommodating port 625 and connected to the upper rod 621 through the rotating shaft 623.

In this way, when the upper rod 621 is pulled out, the wall surface of the receiving opening of the upper rod opposite the end of the lower rod is in contact with the vertical plane of the end of the lower rod, and the inclined surface on the upper rod can limit their relative rotation so that the upper rod can be locked in 90 degrees or approximately 90 degrees upward. Only when there is external force, the upper rod 621 can be rotated along the inclined surface and the arc surface until the upper and lower rods are in a horizontal state. At this state, the upper rod 621 can be retracted into the outer tube of the bearing frame.

According to some embodiments, when the expandable folding table is unfolded and in use, the wheels 81 on the pulley 8 is folded at the bottom of the foldable table top 100, as shown in FIG.s 1 and 6. When the folding table is folded and packed, the wheels 81 of the table stick out of the table for rolling, and the pulling rod 5 is used to push or pull the table, as shown in FIG. 9. The two bearing frames 6a, 6b can hang or carry the objects, as shown in FIG. 10. When packaged and transported, it can be folded into the state shown in FIG. 17, with the size that is equivalent to the size of one panel. Therefore, the expandable folding table not only achieves a multi-purpose function, but also makes it easy to mobilize the table and objects. It also greatly reduces the transportation cost.

In addition, the traditional table is generally folded in half and the two main panels are fastened by plastic clips. Since the present expandable folding table can be used as a cart, objects' weight makes it difficult for the plastic clips to fold the panels together. To this end, the expandable folding table is further provided with a mechanical structure between the first and second panels 1a, 1b. The mechanical structure can adopt a locking mechanism, as shown in FIGS. 17 and 18. The locking mechanism is located adjacent to vacancy 11, and is mainly composed of a lock latch 72 and a lock post 71. The lock latch 72 is provided with a slot for the lock post 71 to be inserted into; the lock post 71 is arranged on the first panel 1a and can be directly riveted to the crosspiece of the first bearing frame 6a.

During operation, the locking or unlocking can be completed by simply manually turning the lock latch 72. Therefore, the locking mechanism can firmly lock the two panels 1a and 1b. Furthermore, the locking mechanism is not exposed, so it does not affect the aesthetics of the table. In addition, when the expandable folding table is packaged and transported, the locking mechanism can be used to lock the wheel modules in the two panels 1a, 1b, so that they will not fall out, as shown in FIGS. 17 and 18. The above is only an embodiment of the locking mechanism, which can also be structurally modified or replaced by other methods.

It is to be understood that even though numerous characteristics and advantages of various embodiments of the present subject matter have been set forth in the foregoing description, together with details of the structure and function of various embodiments of the subject matter, this disclosure is illustrative only. In some cases, certain subassemblies are only described in detail with one such embodiment. Nevertheless, it is recognized and intended that such subassemblies may be used in other embodiments of the subject matter. Practitioners skilled in the art will recognize many modifications and variations. Changes may be made in detail, especially matters of structure and management of parts within the principles of the embodiments of the present subject matter to the full extent indicated by the broad general meaning of the terms in which the appended claims are expressed.

Having disclosed exemplary embodiments and the best mode, modifications and variations may be made to the disclosed embodiments while remaining within the scope of the embodiments of the subject matter as defined by the following claims.

1. An expandable folding table, comprising:
a foldable table top, which includes a first panel and a second panel that are configured to be coupled with each other; and
a foldable table frame, which includes a first frame with a first stand connected to the first panel and a second frame with a second stand connected to the second panel,
wherein the first frame and the second frame are connected by a pivot device and can be folded around a pivot shaft of the pivoting device to link the first panel and the second panel to achieve folding,
wherein the first frame is expandable, which includes a fixed frame connected with the pivot device and a movable frame slidably arranged on the fixed frame, and a movable panel is mounted on the fixed frame; and
wherein the movable frame and the first panel are configured to slide on the fixed frame through a sliding rail device between the movable frame and the fixed frame so that the movable panel can be horizontally arranged between the first panel and the second panel to extend the expandable folding table when it is in use, and wherein the movable panel can be hidden under the first panel when it is collapsed.

2. The expandable folding table of claim 1, wherein the movable panel is rotatably connected to a middle beam of the fixed frame, and the movable panel is foldable with a first board and a second board that are connected to each other.

3. The expandable folding table of claim 2, wherein the fixed frame includes a longitudinal front fixed beam and a longitudinal rear fixed beam, and a horizontal left fixed beam and a horizontal right fixed beam, wherein the longitudinal front fixed beam and the longitudinal rear fixed beam are respectively connected to the front and rear of the pivot device, wherein the horizontal right fixed beam is connected between the front and rear of the pivot device, wherein the movable frame includes a longitudinal front movable beam and a longitudinal rear movable beam, and the longitudinal front movable beam and the longitudinal rear movable beam are slidably arranged on the longitudinal front fixed beam and the longitudinal rear fixed beam, and wherein the middle beam is a longitudinal beam connected between the horizontal left fixed beam and the horizontal right fixed beam.

4. The expandable folding table of claim 3, wherein the first stand is connected with the movable frame.

5. The expandable folding table of claim 3, wherein the sliding rail device further comprises:
the longitudinal front fixed beam and the longitudinal rear fixed beam, each being provided with fixed sliding rail grooves with rolling elements;
the longitudinal front movable beam and the longitudinal rear movable beam are provided with movable sliding rail grooves configured to match with the rolling elements; and
a limiting structure for limiting the movable sliding rail grooves on the fixed sliding rail grooves.

6. The expandable folding table of claim 5, wherein the limiting structure includes one or more limiting blocks and limiting protrusions.

7. The expandable folding table of claim 5, wherein the rolling elements are one of a roller, or a bearing, or a roller.

8. The expandable folding table of claim 2, wherein the first panel and the second panel are either connected by hinges or by a flexible integrated structure.

9. The expandable folding table of claim 2, further comprising:
an anti-detachment device between the first panel and the second panel when the expandable folding table is folded.

10. The expandable folding table of claim 9, wherein the anti-detachment device is a magnet that can attach the first panel and the second panel to each other.

11. The expandable folding table of claim 1, wherein the first panel, the second panel, and the movable panel are blow molding panels, wherein the movable panel has grooves to match with protrusions on the first and second panels when the movable panel is in use.

12. The expandable folding table of claim 1, further comprising:
two wheel modules that can be foldably arranged near the second panel, wherein when the expandable folding table is in use, the wheel modules are configured to be stored under the second panel, wherein when the expandable folding table is collapsed, the wheel modules are configured to be in contact with the ground; and
a pulling rod configured to be pulled out of the second panel is installed at the bottom of the second panel.

13. The expandable folding table of claim 12, further comprising:
at least one bearing frame arranged on the bottom of the first panel and/or the second panel, wherein the at least one bearing frame is configured to be pulled out and locked at a fixed carrying position by a rotating structure.

14. The expandable folding table of claim 13, further comprising:
a locking mechanism between the first panel and the second panel when the expandable folding table is folded.

15-19. (canceled)

20. An expandable folding table, comprising:
a foldable table top, which includes a first panel and a second panel that are configured to be coupled with each other; and
a foldable table frame, which includes a first frame connected to the first panel and a second frame connected to the second panel,
wherein the first frame and the second frame are connected by a pivot device and can be folded around a pivot shaft of the pivoting device to achieve folding, and
wherein the first frame is expandable, which includes a fixed frame connected with the pivot device and a movable frame slidably arranged on the fixed frame, and a movable panel is mounted on the fixed frame.

21. The expandable folding table of claim 20, wherein the movable frame and the first panel are configured to slide on the fixed frame through a sliding rail device between the movable frame and the fixed frame so that the movable panel can be horizontally arranged between the first panel and the second panel to extend the expandable folding table when it is in use, and wherein the movable panel can be hidden under the first panel when it is collapsed.

22. The expandable folding table of claim 20, wherein the movable panel is rotatably connected to the fixed frame, and the movable panel is foldable with a first board and a second board that are connected to each other.

23. The expandable folding table of claim 20, further comprising:
an anti-detachment device between the first panel and the second panel when the expandable folding table is folded.

24. An expandable folding table, comprising:
a foldable table top, which includes a first panel and a second panel that are configured to be coupled with each other; and
a foldable table frame, which includes a first frame connected to the first panel and a second frame connected to the second panel,
two wheel modules that can be foldably arranged near the second panel, wherein when the expandable folding table is in use, the wheel modules are configured to be stored under the second panel, wherein when the expandable folding table is collapsed, the wheel modules are configured to roll on the ground; and
a pulling rod configured to be pulled out of the second panel.

25. The expandable folding table of claim 24, further comprising:
an anti-detachment device between the first panel and the second panel when the expandable folding table is folded.
